(19) United States
(12) Patent Application Publication
(10) Pub. No.: US 2009/0133544 A1
(43) Pub. Date: May 28, 2009

(54) Hand-held power tool with auxiliary handle with depth stop

(75) Inventors: Thomas Hofbrucker, Mammendorf (DE); Ralph Neuhaeuser, Augsburg (DE); Manfred Ludwig, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/291,778

(22) Filed: Nov. 12, 2008

(30) Foreign Application Priority Data
Nov. 28, 2007 (DE) 10 2007 047 883.8

(51) Int. Cl. B25B 23/16; B25G 1/00

(52) U.S. Cl. 81/489; 16/426

(57) ABSTRACT

A hand-held power tool, includes an auxiliary handle (1) having a head (4) positioned relative to an operational axis (A) of the power tool (3), a bar guide (5) extending parallel to the operational axis (A) and arranged in the head (4), a rigid bar (6) formlockingly and displaceably received in the bar guide (5) and serving as a depth stop, a locking member (7) for at least partially frictionally securing the depth stop-forming bar (6), and having at least one locking hole (9) for the depth stop-forming bar (6), and a clamp screw (8) for displacing the locking member (7) in a locking direction.

### BACKGROUND OF THE INVENTION

1. Field of the Invention

The present invention relates to a hand-held power tool with an auxiliary handle having a depth stop and, in particular, to a hammer drill.

2. Description of the Prior Art

Usually, an auxiliary handle is secured on a locking flange of a power tool with a clamp, a clamping yoke, or a clamping band. Often, on the auxiliary handle, there is also provided a depth stop in form of a rigid, displaceably securable bar. At a corresponding use, the depth stop contacts the workpiece surface, absorbing the entire press-on force of the power tool, whereby the operational process, e.g., drilling practically ends.

U.S. Publication US 2004/0163214 discloses an auxiliary handle which can be secured on the locking flange of the hand-held power tool with an elastically preloaded clamp member and which has a head formlockingly adapted to the locking flange and positioned relative to the rotational axis of the power tool when the handle is appropriately secured. In addition, a multi-edge rigid bar, which serves as a depth stop, is formlockingly displaceably secured in the head. For securing the bar, a clamping screw is used which directly presses the bar with its threaded stem upon locking, frictionally securing the bar. The contact surface, which is formed by the threaded stem, is necessarily small and can lead to plastic deformation of the bar upon application of a sufficient locking force. The possible plastic deformation of the bar is contrary to a continuous depth adjustment in the future.

European Publication EP 0132 593 discloses an auxiliary handle that can be secured on the locking flange of a hand-held power tool with a clamping band preloaded by an insert bolt upon rotation of the handle. The auxiliary handle has a head formlockingly adapted to the flange and positioned relative to the rotational axis of the power tool when the handle is appropriately secured. In addition, a hexagonal rigid bar, which serves as a depth stop, in formlockingly displaceably secured in the head. For securing the bar, a spring-biased pressure button, which is displaceable transverse to the rotational axis and has a rippled wedge surface, is used.

European Publication EP 1 336 446 discloses use of a spring-biased lever with a rippled locking surface which automatically directly presses an associated riffled surface of the bar, formlockingly and frictionally securing the bar. For a reliable absorption of the entire press-on force applied to the power tool, in particular during use in construction, such automatically spring-biased securing of the bar is not suitable because the riffled surfaces are subjected to a strong wear, and the adhesion of the cooperating surfaces can be noticeably reduced by grease layers used during the use of the power tools.

Accordingly, an object of the present invention is a hand-held power tool that has an auxiliary handle suitable for rough use in construction and insuring securing the depth stop-forming bar so that the press-on force of the power tool is reliably absorbed, and the depth stop-forming bar is not damaged.

### SUMMARY OF THE INVENTION

This and other objects of the present invention, which will become apparent hereinafter, are achieved by providing a hand-held power tool with an auxiliary handle having a head positioned relative to an operational axis of the power tool and securable to the power tool, a bar guide extending parallel to the operational axis and arranged in the head of the auxiliary handle, a rigid bar formlockingly and displaceably received in the bar guide and serving as a depth stop, a locking member for at least partially frictionally securing the depth stop-forming bar, likewise arranged in the head of the auxiliary handle and having at least one locking hole for the depth stop-forming bar, and a clamp screw for displacing the locking member into its locking direction transverse to the operational direction.

With a locking hole through which the bar extends at an appropriate use and which is displaced transverse to the operational axis, the hole rim forms a contact surface acting against a receptacle upon locking. The contact surface extends over a half of the bar circumference and, thereby, insures a large-surface contact, so that it remains in the elastic region upon absorption of the maximum press-on force at an adequate preloading of the bar material (e.g., steel). Thereby, no lasting plastic deformation is produced.

Advantageously, the auxiliary handle has at least one, preferably two inserts located in the interior of the locking member and each having a bearing surface that forms a large surface contact with the locking member in the locking direction, and at least one counter-locking hole for the bar and which at least partially overlaps the locking hole of the locking member. Thereby, the inserted bar is elastically wedged between the locking hole in the locking member and the counter-locking hole(s) of the insert(s).

Advantageously, the insert(s) is(are) formed as a U-shaped member(s), and has(have) two counter-locking holes provided in the two legs, respectively. Thereby, in comparison with angular inserts, less components are needed. ?The legs of the U-shaped insert extend transverse to the locking direction.

Advantageously, the locking member is also formed as a U-shaped member and has two locking holes formed in two legs of the U-shaped member, respectively. The two locking holes increase the contact surface, and also insure compensation of the bending moments of the deflected legs. The legs of the U-shaped locking member extend along the locking direction.

Advantageously, the U-shaped locking member has a base having an inner thread for the clamp screw, so that the clamp screw is directly screwed in the locking member. The locking member and the insert are formed of metal. Thereby, high locking forces can be transmitted, without any damage, from the bar to the clamp screw.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a hand-held power tool according to the present invention with an auxiliary handle;

FIG. 2 a portion of a cross-sectional view along line II-II in FIG. 1;

FIG. 3 a section III of the cross-sectional view of FIG. 2 at an increased, in comparison with FIG. 2, scale; and

FIG. 4 a longitudinal cross-sectional view along line IV-IV in FIG. 2.

### DETAILED DESCRIPTION OF THE PREFERRED EMBODIMENT

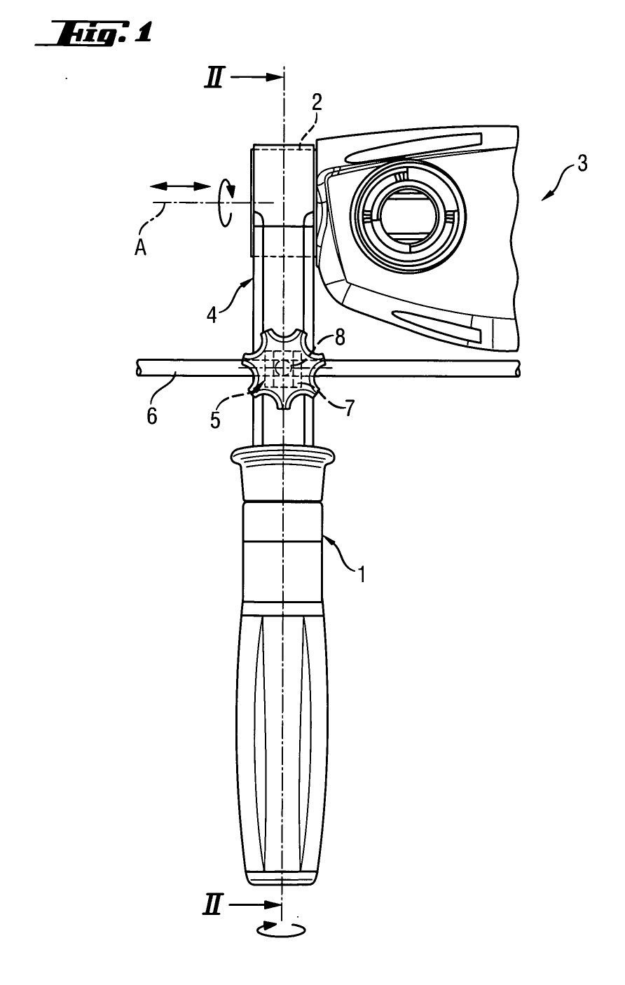

A hand-held power tool 3, which is formed as a hammer drill and is only partially shown in FIG. 1, has a locking flange 2 to which an auxiliary handle 1 that is positioned relative to the operational axis A of the power tool 3, is secured. The auxiliary handle 1 has a head 4 formlockingly adapted to the locking flange 2. In the head 4, a bar guide 5, which extend parallel to the operational axis A, is arranged. The bar guide 5 formlockingly and displaceably receives a rigid bar 6 that forms a depth stop.

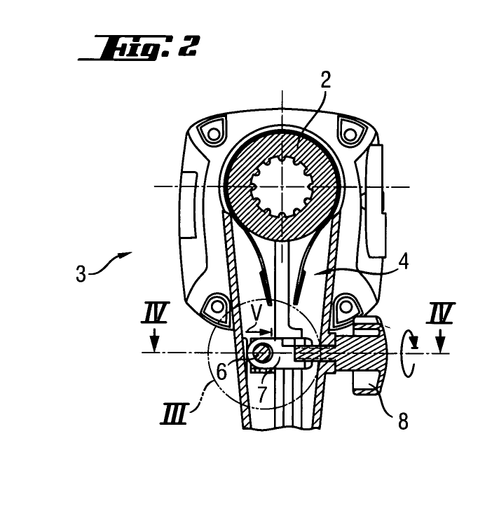

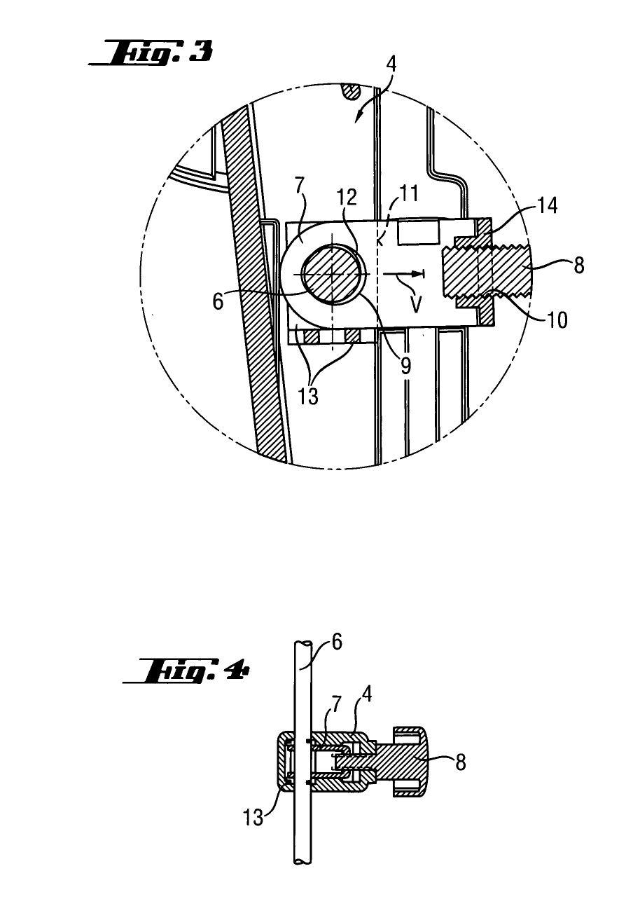

As shown in FIGS. 2, 3 and 4, the head 4 has a metal locking member 7 for frictionally retain the bar 6 that acts independently from locking actions of a rotatable locking handle. The locking member 7 is displaceable along a locking direction V transverse to the operational axis A of the power tool 3 by a clamp screw 8. As shown in FIG. 4, the U-shaped locking member 7 has two locking holes 9 for the bar 6. In the center of the base 14 of the locking member 7, there is provided an inner thread 10 for the clamp screw 8. The head 4 further includes a U-shaped metal insert 13 having a bearing surface 11 that forms, in the locking direction V, a large-surface contact with the inside of the head 4. The U-shaped insert 13 has two counter-locking holes 12 for the bar 6 and which are formed in legs of the insert 13. The counter-locking holes 12 partially overlap the locking holes 9 of the locking member 7. The legs of the U-shaped insert 13 extend transverse to the locking direction V.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool, comprising an auxiliary handle (1) having a head (4) positioned relative to an operational axis (A) of the power tool (3) and securable thereto; a bar guide (5) extending parallel to the operational axis (A) and arranged in the head (4) of the auxiliary handle (1); a rigid bar (6) formlockingly and displaceably received in the bar guide (5) and forming a depth stop; a locking member (7) for at least partially frictionally securing the depth stop-forming bar (6), likewise arranged in the head (4) of the auxiliary handle (1) and having at least one locking hole (9) for the depth stop-forming bar (6); and a clamp screw (8) for displacing the locking member (7) in a locking direction (V) transverse to the operational axis (A).

2. A hand-held power tool according to claim 1, further comprising at least one insert (13) located in an interior of the locking member (7) and having a bearing surface (11) that forms a large surface contact with the locking member (7) in the locking direction (V), and at least one counter-locking hole (12) for the bar (6) and which at least partially overlaps the locking hole (9) of the locking member (7).

3. A hand-held tool according to claim 2, wherein the insert (13) is formed as a U-shaped member, and has two counter-locking holes (12) provided in two legs of the U-shaped member, respectively.

4. A hand-held power tool according to claim 1, wherein the locking member (7) is formed as a U-shaped member and has two locking holes (9) formed in two legs of the U-shaped member, respectively.

5. A hand-held power tool according to claim 1, wherein the locking member (7) has a base (14) having an inner thread (10) for the clamp screw (8).

6. A hand-held power tool according to claim 1, wherein the locking member (7) is formed of metal.

7. An auxiliary handle for a hand-held power tool, comprising a head (4) positioned relative to an operational axis (A) of the power tool (3) and securable thereto; a bar guide (5) extending parallel to the operational axis (A) and arranged in the head (4) of the auxiliary handle (1); a rigid bar (6) formlockingly and displaceably received in the bar guide (5) and forming a depth stop of the power tool; a locking member (7) for at least partially frictionally securing the depth stop-forming bar (6), likewise arranged in the head (4) of he auxiliary handle (1) and having at least one locking hole (9) of the depth stop-forming bar (6); and a clamp screw (8) for displacing the locking member (7) in a locking direction (V) transverse to the operational axis (A).
